(19) United States
(12) Patent Application Publication
(10) Pub. No.: US 2026/0118667 A1
(43) Pub. Date: Apr. 30, 2026

(54) VEHICULAR DISPLAY DEVICE

(71) Applicant: YAZAKI CORPORATION, Tokyo (JP)

(72) Inventors: Teruomi Sano, Makinohara-shi (JP); Terukazu Kuboyama, Shimada-shi (JP); Ryoko Harada, Shimada-shi (JP)

(21) Appl. No.: 19/072,978

(22) Filed: Mar. 6, 2025

Related U.S. Application Data
(63) Continuation of application No. PCT/JP2023/042328, filed on Nov. 27, 2023.

(30) Foreign Application Priority Data
Dec. 27, 2022 (JP) 2022-210353

(51) Int. Cl. G02B 27/01; B60K 35/231

(52) U.S. Cl. CPC G02B 27/0101; B60K 35/231; G02B 27/0149

(57) ABSTRACT

A vehicular display device includes an indicator provided in an instrument panel of a vehicle and configured to emit desired visible information as display light, and an aspherical mirror disposed on an optical path of the display light from the indicator to a windshield of the vehicle and at a position visible from a viewing position of a driver. The aspherical mirror reflects the display light emitted from the indicator to the viewing position, and allows the driver to visually recognize the desired visible information as a virtual image.

### CROSS-REFERENCE TO RELATED APPLICATIONS

The present application is a continuation application of PCT/JP2023/042328 that claims priority to Japanese Patent Application No. 2022-210353 filed on Dec. 27, 2022, the entire content of which is incorporated herein by reference.

### TECHNICAL FIELD

The present disclosure relates to a vehicular display device.

### BACKGROUND ART

In the related art, a vehicle such as an automobile is equipped with a vehicular display device such as a head-up display (HUD). For example, the vehicular display device in the related art is configured such that a display image displayed on an indicator is projected onto a windshield, a combiner, or the like via an optical system such as a reflection mirror, and thus a driver visually recognizes the display image as a virtual image (see JP2018-120807A, for example).

As described above, in the vehicular display device that projects the display image onto the windshield, the display image may not be able to be projected depending on a shape of the windshield. In other words, the vehicular display device described above needs to be designed according to a shape of the windshield for each vehicle.

### SUMMARY OF INVENTION

The present disclosure provides a vehicular display device that is used in common without being affected by specifications (particularly, a shape of a windshield) of a vehicle.

According to an illustrative aspect of the present disclosure, a vehicular display device provided in an instrument panel of a vehicle includes: an indicator configured to emit desired visible information as display light; and an aspherical mirror disposed on an optical path of the display light from the indicator to a windshield of the vehicle and at a position visible from a viewing position of a driver. The aspherical mirror reflects the display light emitted from the indicator to the viewing position to allow the driver to visually recognize the desired visible information as a virtual image.

According to the vehicular display device according to the embodiment of the present disclosure, the display light emitted from the indicator is reflected by the aspherical mirror to the viewing position of the driver, and the desired visible information can be visually recognized by the driver as a virtual image. Accordingly, the vehicular display device can be used in common without being affected by specifications of a vehicle (particularly, a shape of a windshield).

### BRIEF DESCRIPTION OF DRAWINGS

FIG. 1 is a schematic diagram (a side view) showing a schematic configuration of a vehicle equipped with a vehicular display device according to an embodiment of the present disclosure;

FIG. 2 is a schematic diagram showing a schematic configuration of the vehicular display device;

FIG. 3 is an enlarged view of an upper end portion of the vehicular display device;

FIG. 4 is a schematic diagram of the vehicular display device viewed from a viewing position of the driver;

FIG. 5 is a schematic diagram showing an example of dealing with different viewing positions;

FIG. 6 is a schematic diagram showing a display mode of a virtual image; and

FIG. 7 is a diagram corresponding to FIG. 1, and is a schematic diagram showing a state in which an upper portion of a housing portion is covered with an instrument panel upper portion.

### DESCRIPTION OF EMBODIMENTS

Hereinafter, a vehicular display device 1 according to an embodiment of the present disclosure will be described with reference to the drawings.

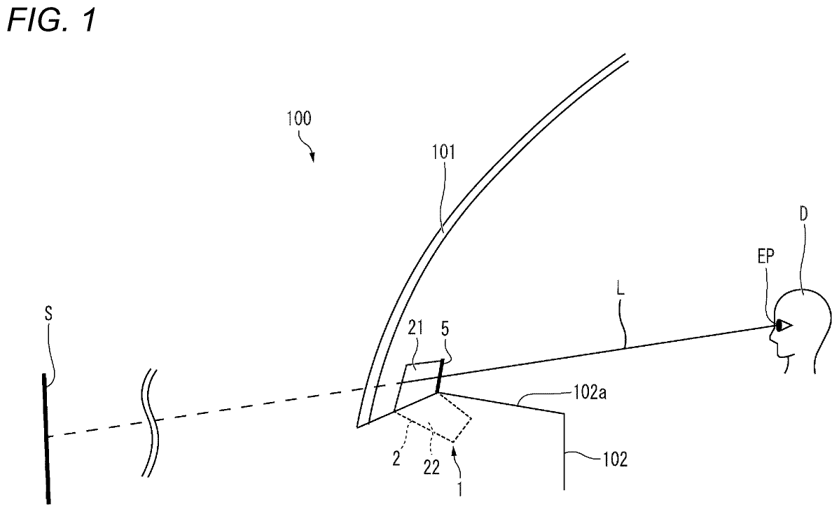

Hereinafter, a schematic configuration of the vehicular display device 1 will be described. As shown in FIG. 1, the vehicular display device 1 is a meter device that is disposed on an instrument panel 102 in a vehicle 100 such as an automobile, and can display various instruments. The vehicular display device 1 can display information of various instruments as a virtual image S, for example, as in a head-up display device. The virtual image S is formed on an extension line of an optical path so as to be present in front of and far from the vehicular display device 1 in a vehicle traveling direction when viewed from a viewing position EP of a driver D.

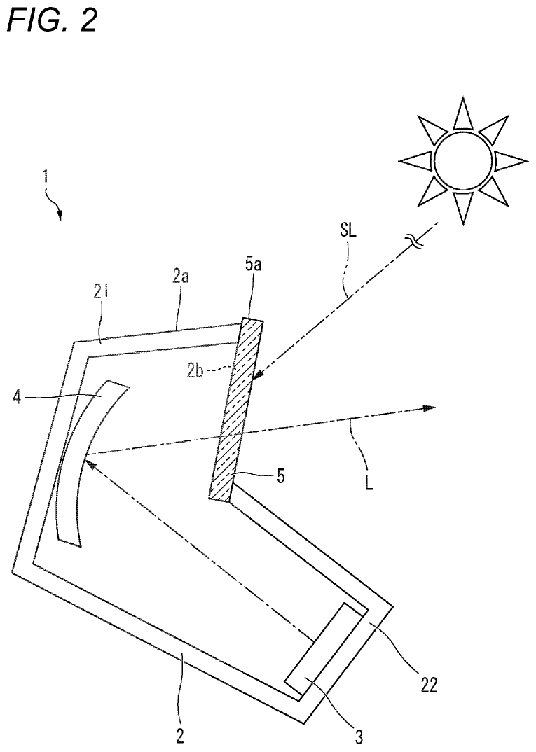

As shown in FIG. 2, the vehicular display device 1 includes a housing portion 2, an indicator 3, an aspherical mirror 4, and a light shielding glass 5 (corresponding to a “light shielding portion” of the present disclosure). The housing portion 2 accommodates and supports, in an internal space thereof, the indicator 3 and the aspherical mirror 4. The housing portion 2 is provided with an opening 2b that establishes communication between the internal space and the outside. The opening 2b is provided at a position facing the driver D in the housing portion 2, and is closed by the light shielding glass 5.

In the present embodiment, the housing portion 2 is formed in a substantially L shape, and an upper portion above a bent portion can be an upper portion 21, and a lower portion below the bent portion can be a lower portion 22. As shown in FIG. 1, in the vehicle 100, the housing portion 2 is provided such that the lower portion 22 is disposed in the instrument panel 102 and the upper portion 21 is erected from an upper face 102a of the instrument panel 102.

The indicator 3 emits, as display light L, desired visible information to be visually recognized as a virtual image S by the driver D of the vehicle 100. In the present embodiment, the indicator 3 is disposed to be inclined with respect to a horizontal direction of the vehicle such that the display light L is emitted in a forward and obliquely upward direction. As the indicator 3, for example, an indicator used in a known head-up display device is used.

As an example, the indicator 3 includes a light source; a display panel that emits light incident from the light source as the display light L; a condenser lens that is disposed on an optical path between the light source and the display panel and condenses the light incident from the light source toward the display panel; a light distribution lens that is disposed between the condenser lens and the display panel on the optical path between the light source and the display panel and distributes the light condensed by the condenser lens toward the display panel; and a wave plate for adjusting a deflection direction of the display panel.

The light source includes a light source substrate on which a plurality of light emitting elements are intensively mounted at a position through which an optical axis of a condenser lens passes when viewed from an optical axis direction of the condenser lens, and each of the light emitting elements is, for example, a light emitting diode (LED).

The display panel is a so-called liquid crystal panel, and is made of, for example, a transparent or semi-transparent thin film transistor (TFT) liquid crystal display.

The condenser lens is made of, for example, a high refractive index material such as glass or a transparent resin, and has a function of refracting light facing the outside inward and condensing the light on the light distribution lens.

The light distribution lens is made of, for example, a material such as glass or a transparent resin, and has a function of refracting and distributing the light toward a display area of the display panel.

The aspherical mirror 4 is a so-called concave mirror whose reflection surface is formed by a concave curved surface, and totally reflects the display light L emitted from the indicator 3 toward the viewing position EP through the light shielding glass 5 to allow the driver D to visually recognize the visible information as the virtual image S. Therefore, the aspherical mirror 4 is disposed on an optical path of the display light L from the indicator 3 to a windshield 101 and at a position visible from the viewing position EP of the driver D, and is disposed to be inclined with respect to the horizontal direction of the vehicle such that the reflection surface faces obliquely downward.

Further, the aspherical mirror 4 has, for example, a function as a magnifying mirror, and magnifies and reflects the visible information such that the visible information represented by the display light L after being reflected by the aspherical mirror 4 is relatively larger than the visible information represented by the display light L before being reflected by the aspherical mirror 4.

The light shielding glass 5 is attached to the housing portion 2 to close the opening 2b of the housing portion 2 and in a state of being erected from the upper face 102a of the instrument panel 102. The light shielding glass 5 is configured to transmit the display light L from the internal space of the housing portion 2 to the outside, and to block or attenuate incidence of external light SL including sunlight from the outside to the internal space. As the light shielding glass 5, a so-called smoke glass or the like is used.

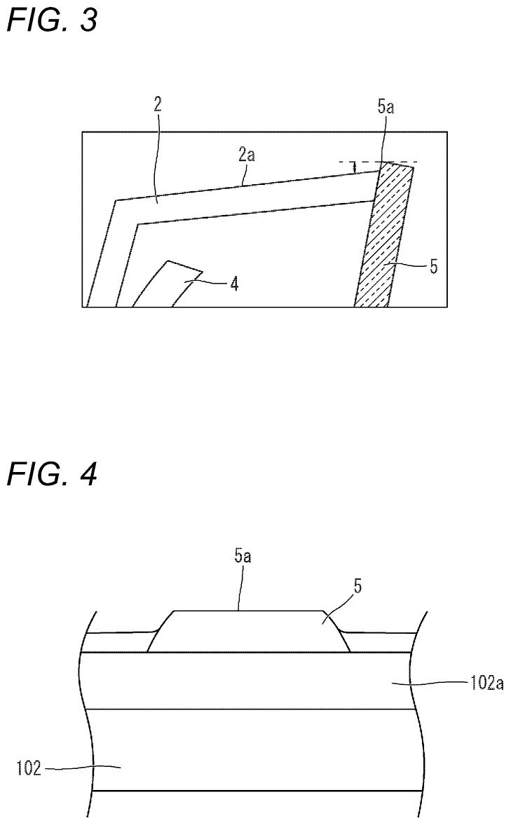

An upper end portion 5a of the light shielding glass 5 protrudes above the upper face 2a of the housing portion 2 (see FIGS. 2 and 3) such that the driver D is not able to visually recognize the housing portion 2 at the viewing position EP (see FIG. 4).

Hereinafter, a virtual image display operation in the vehicular display device 1 will be described. First, the display light L emitted from the indicator 3 travels toward the aspherical mirror 4. The aspherical mirror 4 reflects, by the concave reflection surface, the display light L incident from the indicator 3 toward the viewing position EP of the driver D of the vehicle 100 through the light shielding glass 5. Accordingly, the visible information corresponding to the display light L is displayed as the virtual image S in front of the viewing position EP of the driver D. That is, the driver D can visually recognize the virtual image S as the visible information corresponding to the display light L in front of and far from the vehicular display device in the vehicle traveling direction by visually recognizing the aspherical mirror 4 reflecting the display light L.

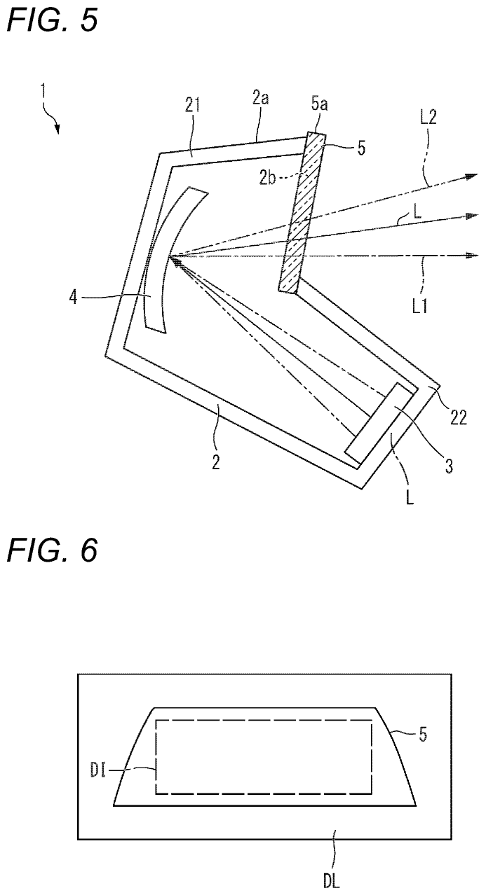

A difference in the viewing position EP of the driver D can be dealt with by the indicator 3 as shown in FIG. 5. A method of dealing with the difference includes, for example, changing an emission angle (reflection position) of the display light L, L1, and L2 from the indicator 3 to the aspherical mirror 4, or changing a display position of the display panel in the indicator 3.

In the present embodiment, as described above, the visible information is enlarged and reflected such that the visible information represented by the display light L after being reflected by the aspherical mirror 4 is increased relatively. Therefore, a displayable range DL of the visible information is larger than a frame of the light shielding glass 5 (see FIG. 6). The vehicular display device 1 displays the visible information using a partial region (display range DI) from the displayable range DL within a range of the frame of the light shielding glass 5 (see FIG. 6). Therefore, the driver D only visually recognizes the visible information corresponding to the display range DI, and does not visually recognize a display frame of the visible information (in other words, a boundary line between the visible information and others). Accordingly, the vehicular display device 1 can realize a so-called seamless appearance.

As the desired visible information in the present embodiment, map information, navigation information, and the like may be displayed in addition to the information of various instruments of the vehicle.

As described above, with respect to a related-art vehicular display device that projects the display light onto the windshield, according to the present embodiment, the display light L emitted from the indicator 3 is reflected by the aspherical mirror 4 to the viewing position EP of the driver D, and the desired visible information can be visually recognized by the driver D as the virtual image S. Accordingly, the vehicular display device 1 can be used in common without being affected by specifications of the vehicle (particularly, a shape of the windshield 101).

Further, according to the present embodiment, since the incidence of the external light SL to the inside of the housing portion 2 can be blocked or attenuated by the light shielding glass 5, it is not necessary to provide a hood portion or the like for excluding the external light in the housing portion 2. That is, the housing portion 2 can be designed without a hood.

Further, according to the present embodiment, since the light shielding glass 5 is attached to the housing portion 2 in a state of being erected from the upper face of the instrument panel 102, visibility of the driver D can be improved.

Further, according to the present embodiment, since the upper end portion 5a of the light shielding glass 5 protrudes above the upper face 2a of the housing portion 2, the driver D is not able to visually recognize the housing portion 2. Accordingly, a design in the vehicle 100 after the vehicular display device 1 is mounted is improved.

Further, according to the present embodiment, as described above, it is possible to realize a hood-less design, a seamless appearance, and the like at low cost.

### OTHER EMBODIMENTS

The present disclosure is not limited to the embodiment described above and can be appropriately modified, improved and the like. In addition, materials, shapes, sizes, numbers, arrangement positions, and the like of components in the embodiment described above are freely selected and are not limited as long as the present disclosure can be implemented.

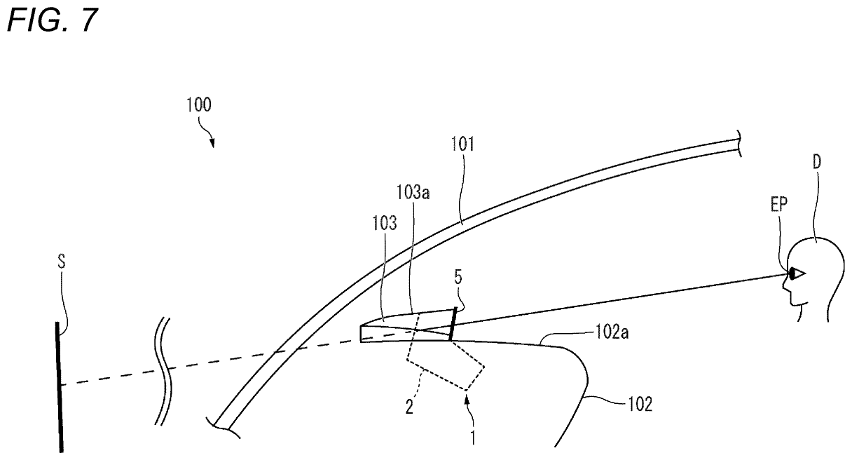

In the above-described embodiment, the upper portion 21 of the housing portion 2 is disposed to be exposed on the upper face 102a of the instrument panel 102, but as shown in FIG. 7, the upper portion 21 of the housing portion 2 may be covered with an instrument panel upper portion 103. In this case, the upper end portion 5a of the light shielding glass 5 preferably protrudes above an upper face 103a of the instrument panel upper portion 103 such that the driver D is not able to visually recognize the upper face 103a of the instrument panel upper portion 103. Accordingly, the design in the vehicle 100 after the vehicular display device 1 is mounted is improved.

Here, features of the embodiment of the vehicular display device according to the present disclosure described above are briefly summarized and listed in the following first to fifth aspects.

According to the first aspect of the present disclosure, a vehicular display device (1) provided in an instrument panel (102) of a vehicle (100) includes: an indicator (3) configured to emit desired visible information as display light (L); and an aspherical mirror (4) disposed on an optical path of the display light (L) from the indicator (3) to a windshield (101) of the vehicle (100) and at a position visible from a viewing position (EP) of a driver (D). The aspherical mirror (4) reflects the display light (L) emitted from the indicator (3) to the viewing position (EP) to allow the driver (D) to visually recognize the desired visible information as a virtual image(S).

With respect to a related-art vehicular display device that projects the display light onto the windshield, according to the configuration of the first aspect, the display light emitted from the indicator is reflected by the aspherical mirror to the viewing position of the driver, and the desired visible information can be visually recognized by the driver as the virtual image. Accordingly, the vehicular display device can be used in common without being affected by specifications of a vehicle (particularly, a shape of the windshield).

According to the second aspect of the present disclosure, in the vehicular display device (1) of the first aspect, at least a part of the aspherical mirror (4) is located above the instrument panel (102) and is disposed to be inclined downward with respect to a horizontal direction of the vehicle (100).

According to the configuration of the second aspect, similarly to the first aspect, the display light emitted from the indicator is reflected by the aspherical mirror to the viewing position of the driver, and the desired visible information can be visually recognized by the driver as the virtual image.

According to the third aspect of the present disclosure, in the vehicular display device (1) of the second aspect, the vehicular display device further includes: a housing portion (2) in which the indicator (3) and the aspherical mirror (4) are accommodated; and a light shielding portion (light shielding glass 5) attached to the housing portion (2) to be located on the optical path from the aspherical mirror (4) to the viewing position (EP). The light shielding portion (light shielding glass 5) is configured to transmit the display light (L) from an inside to an outside of the housing portion (2) and to block or attenuate incidence of external light including sunlight from the outside to the inside.

According to the configuration of the third aspect, since the incidence of the external light to the inside of the housing portion can be blocked or attenuated by the light shielding portion, it is not necessary to provide a hood portion or the like for excluding the external light in the housing portion. That is, the housing portion can be designed without a hood.

According to the fourth aspect of the present disclosure, in the vehicular display device (1) of the third aspect, the light shielding portion (light shielding glass 5) is attached to the housing portion (2) in a state of being erected from an upper face (102a) of the instrument panel (102).

Further, according to the configuration of the fourth aspect, since the light shielding portion is attached to the housing portion in a state of being erected from the upper face of the instrument panel, visibility of the driver can be improved.

According to the fifth aspect of the present disclosure, in the vehicular display device (1) of the fourth aspect, an upper end portion (5a) of the light shielding portion (light shielding glass 5) protrudes above an upper face (2a) of the housing portion such that the driver (D) is not able to visually recognize the housing portion (2).

According to the configuration of the fifth aspect, since the upper end portion of the light shielding portion protrudes above the upper face of the housing portion, the driver is not able to visually recognize the housing portion. Accordingly, a design in the vehicle after the vehicular display device is mounted is improved.

Although the present disclosure has been described in detail with reference to the specific embodiments, it is apparent to those skilled in the art that various changes and modifications can be made without departing from the spirit and scope of the present disclosure.

The present application is based on a Japanese patent application (Japanese Patent Application No. 2022-210353) filed on Dec. 27, 2022, the contents of which are incorporated herein by reference.

What is claimed is:

1. A vehicular display device provided in an instrument panel of a vehicle, the vehicular display device comprising:
an indicator configured to emit desired visible information as display light; and
an aspherical mirror disposed on an optical path of the display light from the indicator to a windshield of the vehicle and at a position visible from a viewing position of a driver, wherein
the aspherical mirror reflects the display light emitted from the indicator to the viewing position to allow the driver to visually recognize the desired visible information as a virtual image, and
a reflection surface of the aspherical mirror is formed by a concave curved surface, and the aspherical mirror magnifies and reflects the visible information such that the visible information represented by the display light after being reflected by the reflection surface is relatively larger than the visible information represented by the display light before being reflected by the reflection surface.

2. The vehicular display device according to claim 1, wherein
at least a part of the aspherical mirror is located above the instrument panel and is disposed to be inclined downward with respect to a horizontal direction of the vehicle.

3. The vehicular display device according to claim 2, further comprising:
a housing portion in which the indicator and the aspherical mirror are accommodated; and
a light shielding portion attached to the housing portion to be located on the optical path from the aspherical mirror to the viewing position, wherein
the light shielding portion is configured to transmit the display light from an inside to an outside of the housing portion and to block or attenuate incidence of external light including sunlight from the outside to the inside, and
a displayable range of the enlarged visible information after being reflected by the reflection surface of the aspherical mirror is larger than a frame of the light shielding portion, such that the driver only visually recognizes the visible information corresponding to a partial region of the displayable range transmitting the light shielding portion.

4. The vehicular display device according to claim 3, wherein
the light shielding portion is attached to the housing portion in a state of being erected from an upper face of the instrument panel.

5. The vehicular display device according to claim 4, wherein
an upper end portion of the light shielding portion protrudes above an upper face of the housing portion such that the driver is not able to visually recognize the housing portion.
